(19) United States
(12) Patent Application Publication
(10) Pub. No.: US 2023/0327163 A1
(43) Pub. Date: Oct. 12, 2023

(54) ELECTROLYTE SHEET FOR SOLID OXIDE FUEL CELLS, METHOD FOR PRODUCING ELECTROLYTE SHEET FOR SOLID OXIDE FUEL CELLS, AND SINGLE CELL FOR SOLID OXIDE FUEL CELLS

(71) Applicant: Murata Manufacturing Co., Ltd., Nagaokakyo-shi (JP)

(72) Inventors: Seiji FUJITA, Nagaokakyo-shi (JP); Hiroaki YAMADA, Nagaokakyo-shi (JP)

(21) Appl. No.: 18/334,669

(22) Filed: Jun. 14, 2023

Related U.S. Application Data
(63) Continuation of application No. PCT/JP2021/045281, filed on Dec. 9, 2021.

(30) Foreign Application Priority Data
Dec. 24, 2020 (JP) 2020-214718

(51) Int. Cl. H01M 8/1253; H01M 8/1213

(52) U.S. Cl. CPC H01M 8/1253; H01M 8/1213; H01M 2008/1293

(57) ABSTRACT

An electrolyte sheet for solid oxide fuel cells that includes a ceramic plate body including ceramic grains containing sintered zirconia, wherein the ceramic grains have a number-based cumulative particle size distribution with a difference of 2.5 μm or more between a particle size D₉₀ at a 90% cumulative probability and a particle size D₁₀ at a 10% cumulative probability.

### CROSS REFERENCE TO RELATED APPLICATIONS

The present application is a continuation of International application No. PCT/JP2021/045281, filed Dec. 9, 2021, which claims priority to Japanese Patent Application No. 2020-214718, filed Dec. 24, 2020, the entire contents of each of which are incorporated herein by reference.

### FIELD OF THE INVENTION

The present invention relates to an electrolyte sheet for solid oxide fuel cells, a method of producing an electrolyte sheet for solid oxide fuel cells, and a unit cell for solid oxide fuel cells.

### BACKGROUND OF THE INVENTION

A solid oxide fuel cell (SOFC) is a device that produces electric energy through reactions of H₂+O²⁻→H₂O+2e⁻ at the fuel electrode and (½)O₂+2e⁻, O²⁻ at the air electrode. A solid oxide fuel cell is a stack of unit cells for solid oxide fuel cells. Each unit cell includes an electrolyte sheet for solid oxide fuel cells, which includes a ceramic plate body, and a fuel electrode and an air electrode disposed on the electrolyte sheet.

As a method of producing an electrolyte sheet for solid oxide fuel cells, Patent Literature 1 discloses a method of producing a scandia-stabilized zirconia sheet, the method including pulverizing sintered scandia-stabilized zirconia to obtain a sintered scandia-stabilized zirconia powder having an average particle size De of more than 0.3 μm and 1.5 μm or less as measured by a transmission electron microscope, an average particle size Dr of more than 0.3 μm and 3.0 μm or less as measured by a laser scattering method, and a ratio Dr/De of 1.0 to 2.5; preparing a slurry containing the sintered scandia-stabilized zirconia powder and an unsintered zirconia powder in which the percentage of the sintered scandia-stabilized zirconia powder with respect to the total of the sintered scandia-stabilized zirconia powder and the unsintered zirconia powder in the slurry is 2 mass % to 40 mass %; molding the slurry into a molded article in a sheet form; and sintering the molded article.
Patent Literature 1: JP 2011-105589 A (JP 4796656 B)

### SUMMARY OF THE INVENTION

However, when an electrolyte sheet for solid oxide fuel cells which includes the scandia-stabilized zirconia sheet produced by the production method according to Patent Literature 1 is made thinner to increase the power generation efficiency of a solid oxide fuel cell, the strength of the electrolyte sheet is decreased.

The present invention was made to solve the above problem and aims to provide a high-strength electrolyte sheet for solid oxide fuel cells. The present invention also aims to provide a method of producing a high-strength electrolyte sheet for solid oxide fuel cells. Further, the present invention aims to provide a unit cell for solid oxide fuel cells, the unit cell including the electrolyte sheet for solid oxide fuel cells.

An electrolyte sheet for solid oxide fuel cells of the present invention includes a ceramic plate body including ceramic grains containing sintered zirconia, wherein the ceramic grains have a number-based cumulative particle size distribution with a difference of 2.5 μm or more between a particle size D₉₀ at a 90% cumulative probability and a particle size D₁₀ at a 10% cumulative probability.

A method of producing an electrolyte sheet for solid oxide fuel cells of the present invention includes: preparing a sintered zirconia powder having a volume-based cumulative particle size distribution with a particle size D₅₀ at a 50% cumulative probability of 3 μm or less and a particle size D₉₉ at a 99% cumulative probability of 6 μm or more; preparing a ceramic slurry by mixing the sintered zirconia powder and an unsintered zirconia powder such that a weight percentage of the sintered zirconia powder with respect to a total weight of the sintered zirconia powder and the unsintered zirconia powder is 5 wt % to 50 wt %; molding the ceramic slurry into a ceramic green sheet; and sintering the ceramic green sheet to produce a ceramic plate body.

A unit cell for solid oxide fuel cells of the present invention includes: a fuel electrode; an air electrode; and the electrolyte sheet for solid oxide fuel cells of the present invention between the fuel electrode and the air electrode.

The present invention can provide a high-strength electrolyte sheet for solid oxide fuel cells. The present invention can also provide a method of producing a high-strength electrolyte sheet for solid oxide fuel cells. Further, the present invention can provide a unit cell for solid oxide fuel cells, the unit cell including the electrolyte sheet for solid oxide fuel cells.

### BRIEF DESCRIPTION OF THE DRAWINGS

FIG. 1 is a schematic plan view of an example of an electrolyte sheet for solid oxide fuel cells of the present invention.

FIG. 2 is a schematic cross-sectional view of a portion taken along line A1-A2 in FIG. 1.

FIG. 3 is a schematic plan view of producing ceramic green sheets in an example of a method of producing an electrolyte sheet for solid oxide fuel cells of the present invention.

FIG. 4 is another schematic plan view of producing ceramic green sheets in the example of the method of producing an electrolyte sheet for solid oxide fuel cells of the present invention.

FIG. 5 is yet another schematic plan view of producing ceramic green sheets in the example of the method of producing an electrolyte sheet for solid oxide fuel cells of the present invention.

FIG. 6 is a schematic cross-sectional view of an embodiment in which an unsintered plate body is produced in producing a ceramic plate body in the example of the method of producing an electrolyte sheet for solid oxide fuel cells of the present invention.

FIG. 7 is a schematic cross-sectional view of an embodiment in which an unsintered plate body is fired in producing a ceramic plate body in the example of the method of producing an electrolyte sheet for solid oxide fuel cells of the present invention.

FIG. 8 is a schematic cross-sectional view of an example of a unit cell for solid oxide fuel cells of the present invention.

FIG. 9 is a graph of a ceramic grain size probability distribution in an electrolyte sheet of Example 1.

FIG. 10 is a graph of a number-based cumulative particle size distribution of the ceramic grains in the electrolyte sheet of Example 1.

### DETAILED DESCRIPTION OF THE PREFERRED EMBODIMENTS

The electrolyte sheet for solid oxide fuel cells (hereinafter, also referred to as the electrolyte sheet) of the present invention, the method of producing an electrolyte sheet for solid oxide fuel cells (hereinafter, also referred to as the method of producing an electrolyte sheet) of the present invention, and the unit cell for solid oxide fuel cells (hereinafter, also referred to as the unit cell) of the present invention are described below. The present invention is not limited to the following preferred embodiments and may be appropriately modified without departing from the gist of the present invention. Combinations of two or more preferred features described in the following preferred features are also within the scope of the present invention.

The drawings are schematic drawings, and the dimensions, the aspect ratio, the scale, and other parameters may differ from those of the actual products.

Electrolyte Sheet for Solid Oxide Fuel Cells

An example of the electrolyte sheet for solid oxide fuel cells of the present invention is described below.

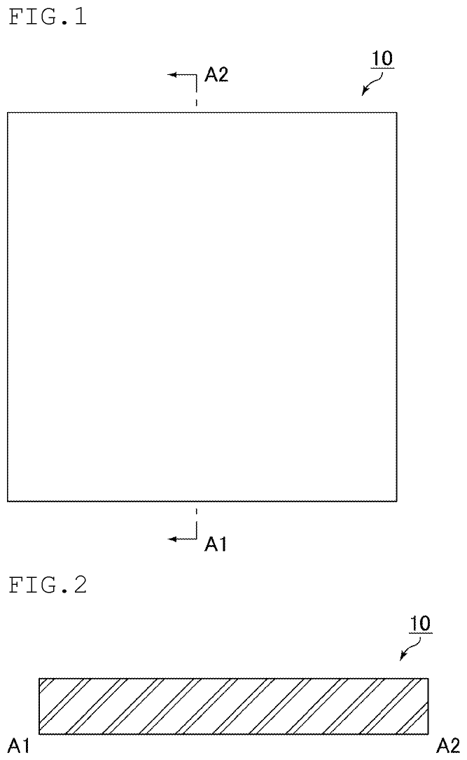

FIG. 1 is a schematic plan view of an example of the electrolyte sheet for solid oxide fuel cells of the present invention. FIG. 2 is a schematic cross-sectional view of a portion taken along line A1-A2 in FIG. 1.

An electrolyte sheet 10 for solid oxide fuel cells shown in FIG. 1 and FIG. 2 includes a ceramic plate body including ceramic grains containing sintered zirconia.

Examples of the sintered zirconia include those stabilized with an oxide of a rare-earth element such as scandium or yttrium. Specific examples include sintered scandia-stabilized zirconia and sintered yttria-stabilized zirconia.

Preferably, the sintered zirconia is sintered scandia-stabilized zirconia. The electrolyte sheet 10 including a ceramic plate body containing sintered scandia-stabilized zirconia has a higher conductivity. In this case, the electrolyte sheet 10, when incorporated into a solid oxide fuel cell, increases the power generation efficiency of the solid oxide fuel cell.

Preferably, the sintered zirconia is sintered cubic zirconia. The electrolyte sheet 10 including a ceramic plate body containing sintered cubic zirconia has a higher conductivity. In this case, the electrolyte sheet 10, when incorporated into a solid oxide fuel cell, increases the power generation efficiency of the solid oxide fuel cell.

Examples of the sintered cubic zirconia include those stabilized with an oxide of a rare-earth element such as scandium or yttrium. Specific examples include sintered scandia-stabilized cubic zirconia and sintered yttria-stabilized cubic zirconia.

Preferably, the sintered cubic zirconia is sintered scandia-stabilized cubic zirconia. The electrolyte sheet 10 including a ceramic plate body containing sintered scandia-stabilized cubic zirconia has a significantly higher conductivity. In this case, the electrolyte sheet 10, when incorporated into a solid oxide fuel cell, significantly increases the power generation efficiency of the solid oxide fuel cell.

In a plan view from a thickness direction of the electrolyte sheet 10, the electrolyte sheet 10 has a square shape as shown in FIG. 1, for example.

In a plan view from the thickness direction, the electrolyte sheet 10 preferably has a substantially rectangular shape with rounded corners, more preferably a substantially square shape with rounded corners (not shown). In this case, all the corners of the electrolyte sheet 10 may be rounded, or one or some corners thereof may be rounded.

Preferably, the electrolyte sheet 10 is provided with a through hole (not shown) penetrating the electrolyte sheet 10 in the thickness direction. Such a through hole functions as a gas flow path in a solid oxide fuel cell.

Only one through hole may be provided, or two or more through holes may be provided.

In a plan view from the thickness direction, the through hole may have a circular shape or any other shape.

The through hole may be provided at any position.

In a plan view from the thickness direction, the electrolyte sheet 10 has a size of, for example, 50 mm×50 mm, 100 mm×100 mm, 110 mm×110 mm, 120 mm×120 mm, or 200 mm×200 mm.

The electrolyte sheet 10 (ceramic plate body) has a thickness of preferably 200 μm or less, more preferably 130 μm or less. Also, the electrolyte sheet 10 has a thickness of preferably 30 μm or more, more preferably 50 μm or more.

The thickness of the electrolyte sheet 10 is determined as follows. First, the thickness is measured at randomly selected nine sites within a region excluding the portions 5 mm inside the outer edge of the electrolyte sheet 10, using a U-shape Frame Sheet Metal Micrometer (available from Mitutoyo Corporation, PMU-MX). The average of the thicknesses measured at the nine sites is calculated and regarded as the thickness of the electrolyte sheet 10.

Preferably, recesses (not shown) are scattered on at least one main surface of the electrolyte sheet 10. When the electrolyte sheet 10 in which recesses are scattered on at least one main surface thereof is incorporated into a solid oxide fuel cell, the electrode has a larger contact area with gas owing to the recesses, resulting in a higher power generation efficiency of the solid oxide fuel cell. The recesses may be scattered only on one main surface of the electrolyte sheet 10, but particularly preferably, the recesses are scattered on both one main surface and the other main surface thereof.

In the electrolyte sheet 10, the ceramic grains have a number-based cumulative particle size distribution with a difference of 2.5 μm or more between a particle size D₉₀ at a 90% cumulative probability and a particle size D₁₀ at a 10% cumulative probability.

When an electrolyte sheet is incorporated into a solid oxide fuel cell, the electrolyte sheet is subjected to a load due to application of a slurry for a fuel electrode and a slurry for an air electrode to the electrolyte sheet or stacking of a unit cell including a fuel electrode and an air electrode on the electrolyte sheet, with a separator. Thus, an electrolyte sheet with low strength is easily broken by such a load applied thereto. When an electrolyte sheet is broken, usually, a crack in the electrolyte sheet grows through a ceramic grain.

In contrast, in the electrolyte sheet 10, the ceramic grains have a number-based cumulative particle size distribution satisfying the above conditions, resulting in widening of the ceramic grain size probability distribution and the presence of large-sized ceramic grains. Thus, in the electrolyte sheet 10, the large-sized ceramic grains suppress the growth of a crack and contribute to suppressing a decrease in strength. As a result, the high-strength electrolyte sheet 10 is achieved. The high-strength electrolyte sheet 10 is not easily broken by a load applied thereto when it is incorporated into a solid oxide fuel cell.

The number-based cumulative particle size distribution of the ceramic grains in the electrolyte sheet is determined as follows. First, a randomly selected site (e.g., a central portion) of the electrolyte sheet is observed at a magnification of 3000 times with a tabletop microscope “TM3000” available from Hitachi High-Tech Corporation, and an image of a region including 100 or more ceramic grains and having a size of 30 μm×30 μm is taken. Next, the image is analyzed by an image analysis measurement system “WinROOF2018 grain boundary extraction module” available from Mitani Corporation, whereby the particle size of each of 100 or more ceramic grains is measured as the equivalent circle diameter. Subsequently, the “NORMDIST” function (or the “NORM.DIST” function) of spreadsheet software “Microsoft Excel” available from Microsoft Corporation is applied to the result of each ceramic grain size measurement with the “TRUE” function, whereby the cumulative probability equal to or smaller than the ceramic grain size is calculated. Then, the number-based cumulative particle size distribution of the ceramic grains is determined from the given cumulative probability.

In the number-based cumulative particle size distribution of the ceramic grains as determined above with a particle size D₉₀ at a 90% cumulative probability and a particle size D₁₀ at a 10% cumulative probability, the difference between the particle size D₉₀ and the particle size D₁₀ is 2.5 μm or more. In the electrolyte sheet 10, the ceramic grains have a number-based cumulative particle size distribution with a difference of preferably 2.6 μm or more between the particle size D₉₀ and the particle size D₁₀.

In the electrolyte sheet 10, the ceramic grains have a number-based cumulative particle size distribution with a difference of preferably 3.5 μm or less, more preferably 3.1 μm or less between the particle size D₉₀ and the particle size D₁₀.

In the electrolyte sheet 10, the ceramic grains have a number-based cumulative particle size distribution with a particle size D₉₀ of preferably 3 μm to 4 μm, more preferably 3.2 μm to 3.8 μm.

In the electrolyte sheet 10, the ceramic grains have a number-based cumulative particle size distribution with a particle size D₁₀ of preferably 0.5 μm to 1 μm, more preferably 0.7 μm to 0.9 μm.

When the “NORMDIST” function (or the “NORM.DIST” function) of spreadsheet software “Microsoft Excel” available from Microsoft Corporation is applied to the result of each ceramic grain size measurement with the “FALSE” function, the probability density of the ceramic grain size can be calculated. Then, the ceramic grain size probability distribution can be determined from the probability density obtained. The ceramic grain size probability distribution in the electrolyte sheet 10 determined as described above shows that the probability distribution is wide with the presence of large-sized ceramic grains.

Method of Producing Electrolyte Sheet for Solid Oxide Fuel Cells

An example of the method of producing an electrolyte sheet for solid oxide fuel cells of the present invention is described below.

Preparing Sintered Zirconia Powder

A sintered zirconia powder is prepared which has a volume-based cumulative particle size distribution with a particle size D₅₀ (also referred to as “median diameter”) at a 50% cumulative probability of 3 μm or less and a particle size D₉₉ at a 99% cumulative probability of 6 μm or more.

As described above, when an electrolyte sheet is broken, usually, a crack in the electrolyte sheet grows through a ceramic grain. Thus, crack growth is easily suppressed in an electrolyte sheet in which the ceramic grain size probability distribution is wide with the presence of large-sized ceramic grains.

The production method of the present invention uses a sintered zirconia powder having a volume-based cumulative particle size distribution with a particle size D₅₀ of 3 μm or less and a particle size D₉₉ of 6 μm or more to obtain an electrolyte sheet in which the ceramic grain size probability distribution is wide with the presence of large-sized ceramic grains.

In the production method of the present invention, as described later, a ceramic slurry containing a mixture of a sintered zirconia powder and an unsintered zirconia powder is molded and then sintered to produce an electrolyte sheet. Here, in order to provide a sintered zirconia powder with sinterability similar to that of an unsintered zirconia powder, it is important to use a sintered zirconia powder having a volume-based cumulative particle size distribution with a particle size D₅₀ of 3 μm or less. Further, when the sintered zirconia powder has a volume-based cumulative particle size distribution with a particle size D₉₉ of 6 μm or more, coarse grains each having a grain size of 6 μm or more will act as the nucleus of grain growth, promoting the overall growth of the grains during sintering of the ceramic slurry. As described later, this results in an electrolyte sheet in which the ceramic grain size probability distribution is wide with the presence of large-sized ceramic grains.

The volume-based cumulative particle size distribution of the sintered zirconia powder is determined as follows. First, the particle size distribution of the sintered zirconia powder is measured by a laser scattering method with a laser diffraction particle size distribution measuring device. Here, the particle size of the sintered zirconia powder is measured as the equivalent circle diameter. Then, the resulting particle size distribution of the sintered zirconia powder is converted into a cumulative probability distribution, whereby the volume-based cumulative particle size distribution of the sintered zirconia powder is determined.

In the volume-based cumulative particle size distribution of the sintered zirconia powder as determined above with a particle size D₅₀ at a 50% cumulative probability and a particle size D₉₉ at a 99% cumulative probability, the sintered zirconia powder for use in the production method of the present invention has a particle size D₅₀ of 3 μm or less and a particle size D₉₉ of 6 μm or more.

The sintered zirconia powder has a volume-based cumulative particle size distribution with a particle size D₅₀ of 3 μm or less, preferably 2.5 μm or less.

The sintered zirconia powder has a volume-based cumulative particle size distribution with a particle size D₅₀ of preferably 0.5 μm or more, more preferably 1.5 μm or more.

The sintered zirconia powder has a volume-based cumulative particle size distribution with a particle size D₉₉ of 6 μm or more, preferably 6.1 μm or more.

The sintered zirconia powder has a volume-based cumulative particle size distribution with a particle size D₉₉ of preferably 8.5 μm or less, more preferably 7.9 μm or less.

In this step, preferably, the sintered zirconia powder is prepared by pulverizing sintered zirconia.

When preparing a sintered zirconia powder by pulverizing sintered zirconia, the sintered zirconia as a raw material of the sintered zirconia powder is, for example, one obtained by sintering an unsintered zirconia powder. Such sintered zirconia may be an electrolyte sheet containing sintered zirconia. Use of a defective electrolyte sheet with warpage, breakage, or the like or an electrolyte sheet incorporated into a solid oxide fuel cell, for example, is preferred in terms of recycling. When using an electrolyte sheet incorporated into a solid oxide fuel cell, for example, the electrolyte sheet may be taken out from a used unit cell, a defective unit cell, or the like by removing a fuel electrode and an air electrode.

Examples of the sintered zirconia include those stabilized with an oxide of a rare-earth element such as scandium or yttrium. Specific examples include sintered scandia-stabilized zirconia and sintered yttria-stabilized zirconia.

Preferably, the sintered zirconia is sintered scandia-stabilized zirconia. In other words, preferably, the sintered zirconia powder is a sintered scandia-stabilized zirconia powder. An electrolyte sheet with high conductivity can be produced with the use of a sintered scandia-stabilized zirconia powder. In this case, the produced electrolyte sheet, when incorporated into a solid oxide fuel cell, can increase the power generation efficiency of the solid oxide fuel cell.

Preferably, the sintered zirconia is sintered cubic zirconia. In other words, preferably, the sintered zirconia powder is a sintered cubic zirconia powder. An electrolyte sheet with high conductivity can be produced with the use of a sintered cubic zirconia powder. In this case, the produced electrolyte sheet, when incorporated into a solid oxide fuel cell, can increase the power generation efficiency of the solid oxide fuel cell.

Examples of the sintered cubic zirconia include those stabilized with an oxide of a rare-earth element such as scandium or yttrium. Specific examples include sintered scandia-stabilized cubic zirconia and sintered yttria-stabilized cubic zirconia.

Preferably, the sintered cubic zirconia is sintered scandia-stabilized cubic zirconia. In other words, preferably, the sintered zirconia powder is a sintered scandia-stabilized cubic zirconia powder. An electrolyte sheet with significantly high conductivity can be produced with the use of a sintered scandia-stabilized cubic zirconia powder. In this case, the produced electrolyte sheet, when incorporated into a solid oxide fuel cell, can significantly increase the power generation efficiency of the solid oxide fuel cell.

Preferably, dry pulverization is performed for pulverizing the sintered zirconia. Dry pulverization can pulverize the sintered zirconia by a strong impact force, which tends to increase the pulverization efficiency.

For example, a jet mill, a vibration mill, a planetary mill, a dry ball mill, a fine mill, or the like is used as a dry pulverizer for dry pulverization.

For example, zirconia balls or the like are used as pulverization media for a dry pulverizer.

When dry-pulverizing the sintered zirconia, the pulverization conditions such as rotation number of a classifying rotor of a dry pulverizer and pulverization time are adjusted, whereby a sintered zirconia powder having the volume-based cumulative particle size distribution described above can be obtained.

When pulverizing the sintered zirconia, wet pulverization may be performed instead of dry pulverization; or dry pulverization and wet pulverization may be performed in combination. Performing only dry pulverization is preferred in terms of pulverization efficiency.

Preparing Ceramic Slurry

A ceramic slurry is prepared by mixing the sintered zirconia powder and an unsintered zirconia powder such that the weight percentage of the sintered zirconia powder with respect to the total weight of the sintered zirconia powder and the unsintered zirconia powder is 5 wt % to 50 wt %.

In this step, preferably, the sintered zirconia powder and an unsintered zirconia powder are mixed such that the weight percentage of the sintered zirconia powder with respect to the total weight of the sintered zirconia powder and the unsintered zirconia powder is 5 wt % to 30 wt %.

When preparing a ceramic slurry, if the weight percentage of the sintered zirconia powder with respect to the total weight of the sintered zirconia powder and the unsintered zirconia powder is less than 5 wt %, the weight percentage of coarse grains in the sintered zirconia powder will be too low to promote the overall growth of the grains during sintering of the ceramic slurry.

When preparing a ceramic slurry, if the weight percentage of the sintered zirconia powder with respect to the total weight of the sintered zirconia powder and the unsintered zirconia powder is more than 50 wt %, the weight percentage of coarse grains in the sintered zirconia powder will be too high, resulting in poor sinterability of the ceramic slurry. This results in a decrease in strength of an electrolyte sheet to be obtained.

Preferably, the unsintered zirconia powder has a volume-based cumulative particle size distribution with a particle size D₅₀ at a 50% cumulative probability of 0.1 μm to 0.3 μm and a particle size D₉₉ at a 99% cumulative probability of 1.5 μm to 2.5 μm.

Examples of the unsintered zirconia powder include those stabilized with an oxide of a rare-earth element such as scandium or yttrium. Specific examples include an unsintered scandia-stabilized zirconia powder and an unsintered yttria-stabilized zirconia powder.

Preferably, the unsintered zirconia powder is an unsintered scandia-stabilized zirconia powder. An electrolyte sheet with high conductivity can be produced with the use of an unsintered scandia-stabilized zirconia powder. In this case, the produced electrolyte sheet, when incorporated into a solid oxide fuel cell, can increase the power generation efficiency of the solid oxide fuel cell.

Preferably, the unsintered zirconia powder is an unsintered cubic zirconia powder. An electrolyte sheet with high conductivity can be produced with the use of an unsintered cubic zirconia powder. In this case, the produced electrolyte sheet, when incorporated into a solid oxide fuel cell, can increase the power generation efficiency of the solid oxide fuel cell.

Examples of the unsintered cubic zirconia powder include those stabilized with an oxide of a rare-earth element such as scandium or yttrium. Specific examples include an unsintered scandia-stabilized cubic zirconia powder and an unsintered yttria-stabilized cubic zirconia powder.

Preferably, the unsintered cubic zirconia powder is an unsintered scandia-stabilized cubic zirconia powder. An electrolyte sheet with significantly high conductivity can be produced with the use of an unsintered scandia-stabilized cubic zirconia powder. In this case, the produced electrolyte sheet, when incorporated into a solid oxide fuel cell, can significantly increase the power generation efficiency of the solid oxide fuel cell.

When preparing a ceramic slurry, a binder, a dispersant, an organic solvent, and the like may be appropriately added in addition to the sintered zirconia powder and the unsintered zirconia powder.

Producing of Ceramic Green Sheet

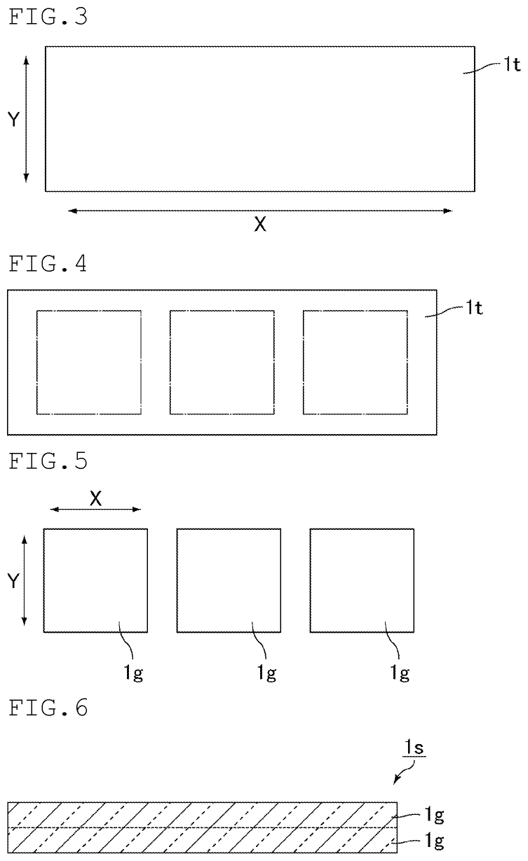

FIG. 3 is a schematic plan view of producing ceramic green sheets in an example of the method of producing an electrolyte sheet for solid oxide fuel cells of the present invention. FIG. 4 is another schematic plan view of producing ceramic green sheets in the example of the method of producing an electrolyte sheet for solid oxide fuel cells of the present invention. FIG. 5 is yet another schematic plan view of producing ceramic green sheets in the example of the method of producing an electrolyte sheet for solid oxide fuel cells of the present invention.

First, a ceramic slurry is molded on one main surface of a carrier film to produce a ceramic green tape it shown in FIG. 3.

The ceramic slurry is molded preferably by tape casting, more preferably by doctor blading or calendaring. FIG. 3 shows molding of the ceramic slurry by tape casting, with the casting directions for the tape casting indicated by X and the directions perpendicular to casting directions indicated by Y.

Then, as shown in FIG. 4, the ceramic green tape it is punched by a known technique into pieces having a predetermined size, and the carrier film is peeled off, whereby the ceramic green sheet 1g shown in FIG. 5 is produced. The punching of the ceramic green tape it and the peeling off of the carrier film may be performed in any order.

Producing Ceramic Plate Body

First, an unsintered plate body including the ceramic green sheet is produced.

FIG. 6 is a schematic cross-sectional view of an embodiment in which an unsintered plate body is produced in the producing of the ceramic plate body in the example of the method of producing an electrolyte sheet for solid oxide fuel cells of the present invention.

As shown in FIG. 6, two ceramic green sheets 1g are stacked and compression-bonded to produce an unsintered plate body 1s. Thus, the unsintered plate body 1s is considered as including the ceramic green sheets 1g.

The unsintered plate body 1s may be produced using two ceramic green sheets 1g as shown in FIG. 6 or three or more ceramic green sheets 1g. These ceramic green sheets 1g may be compression-bonded or simply stacked on one another without being compression-bonded. When the unsintered plate body 1s includes multiple ceramic green sheets 1g, the thickness of a ceramic plate body to be obtained can be controlled in an appropriate and simple manner.

The unsintered plate body 1s may be produced using one ceramic green sheet 1g. In this case, the step shown in FIG. 6 is omitted.

Next, recesses (not shown) scattered on one main surface of the unsintered plate body 1s may be formed. For example, a mold having protrusions scattered on its surface is pressed against one main surface of the unsintered plate body 1s to form recesses scattered thereon.

The protrusions scattered on the mold may be arranged regularly or irregularly.

The recesses may be scattered on both one main surface and the other main surface of the unsintered plate body 1s.

No recesses may be scattered on either one main surface or the other main surface of the unsintered plate body 1s.

Next, a through hole (not shown) penetrating the unsintered plate body 1s in the thickness direction may be formed.

Preferably, a drill is used to form a through hole in the unsintered plate body 1s. In this case, the unsintered plate body 1s is drilled from one main surface to the other main surface thereof, whereby a through hole penetrating the unsintered plate body 1s in the thickness direction is formed. The drilling may be performed under any conditions.

Only one through hole may be formed, or two or more through holes may be formed.

No through hole may be formed.

When forming the recesses and the through hole(s) described above in the unsintered plate body 1s, the forming of the recesses and the forming of the through hole(s) may be performed in any order.

Next, the unsintered plate body 1s is sintered into a ceramic plate body.

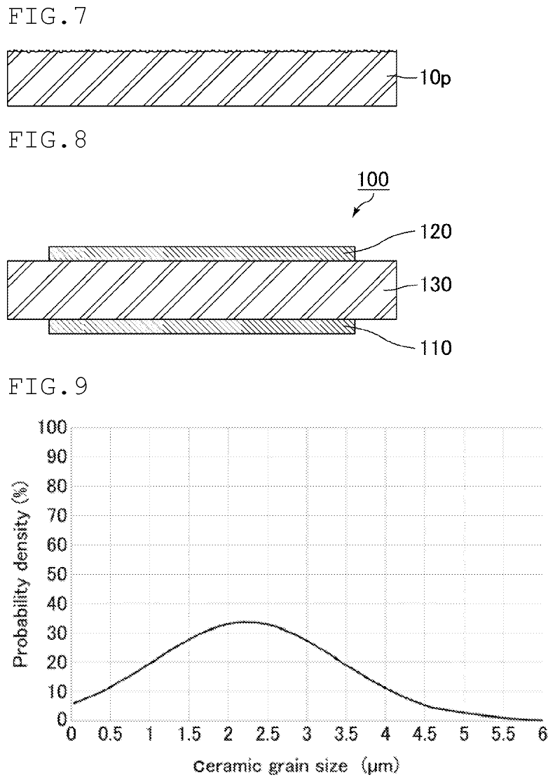

FIG. 7 is a schematic cross-sectional view of an embodiment in which an unsintered plate body is fired in the producing of the ceramic plate body in the example of the method of producing an electrolyte sheet for solid oxide fuel cells of the present invention.

The unsintered plate body 1s is fired, whereby the unsintered plate body 1s is sintered into a ceramic plate body 10p as shown in FIG. 7. The ceramic plate body 10p contains sintered zirconia.

Preferably, the firing of the unsintered plate body 1s includes degreasing and sintering.

When recesses are scattered on one main surface of the unsintered plate body 1s, recesses will be scattered also on one main surface of the ceramic plate body 10p as shown in FIG. 7.

When recesses are scattered on both one main surface and the other main surface of the unsintered plate body 1s, recesses will be scattered also on both one main surface and the other main surface of the ceramic plate body 10p.

When the ceramic plate body 10p includes the recesses described above, these recesses may be arranged regularly or irregularly.

A ceramic plate body without recesses scattered on one main surface or the other main surface may be produced.

When the unsintered plate body 1s is provided with a through hole, the ceramic plate body 10p will be provided with a through hole penetrating therethrough in the thickness direction.

Thus, an electrolyte sheet including the ceramic plate body 10p is produced.

As described above, in the production method of the present invention, a sintered zirconia powder having a volume-based cumulative particle size distribution with a particle size D₅₀ of 3 μm or less and a particle size D₉₉ of 6 μm or more is prepared in the preparing of the sintered zirconia powder, and further, the weight percentage of the sintered zirconia powder with respect to the total weight of the sintered zirconia powder and the unsintered zirconia powder is adjusted to 50 wt % or less in the preparing of the ceramic slurry. Thus, the ceramic plate body 10p produced using such a ceramic slurry has a higher strength because the ceramic grain size probability distribution is wide with the presence of large-sized ceramic grains. More specifically, the ceramic plate body 10p has a higher strength, with the ceramic grains having a number-based cumulative particle size distribution with a difference of 2.5 μm or more between the particle size D₉₀ and the particle size D₁₀. In other words, the production method of the present invention can produce the electrolyte sheet for solid oxide fuel cells of the present invention, the electrolyte sheet including the ceramic plate body 10p.

Unit Cell for Solid Oxide Fuel Cells

An example of a unit cell for solid oxide fuel cells of the present invention is described below.

FIG. 8 is a schematic cross-sectional view of an example of the unit cell for solid oxide fuel cells of the present invention.

As shown in FIG. 8, a unit cell 100 for solid oxide fuel cells includes a fuel electrode 110, an air electrode 120, and an electrolyte sheet 130. The electrolyte sheet 130 is disposed between the fuel electrode 110 and the air electrode 120.

The fuel electrode 110 may be a known fuel electrode for solid oxide fuel cells.

The air electrode 120 may be a known air electrode for solid oxide fuel cells.

The electrolyte sheet 130 is the electrolyte sheet for solid oxide fuel cells of the present invention (e.g., the electrolyte sheet 10 shown in FIG. 1 and FIG. 2). Thus, the unit cell 100, when incorporated into a solid oxide fuel cell, increases the power generation efficiency of the solid oxide fuel cell.

Method of Producing Unit Cell for Solid Oxide Fuel Cells

An example of the method of producing a unit cell for solid oxide fuel cells of the present invention is described below.

First, a powder of a material of a fuel electrode is appropriately mixed with a binder, a dispersant, a solvent, and the like to prepare a slurry for a fuel electrode. Also, a powder of a material of an air electrode is appropriately mixed with a binder, a dispersant, a solvent, and the like to prepare a slurry for an air electrode.

The material of a fuel electrode may be a known material of a fuel electrode for solid oxide fuel cells.

The material of an air electrode may be a known material of an air electrode for solid oxide fuel cells.

The binder, dispersant, solvent, and other additives in the slurry for a fuel electrode and the slurry for an air electrode may be those known in a method of forming a fuel electrode and an air electrode for solid oxide fuel cells.

Next, the slurry for a fuel electrode is applied to a predetermined thickness to one main surface of the electrolyte sheet, and the slurry for an air electrode is applied to a predetermined thickness to the other main surface of the electrolyte sheet. Then, these coatings are dried to form a green layer for a fuel electrode and a green layer for an air electrode.

The green layer for a fuel electrode and the green layer for an air electrode are then fired to form a fuel electrode and an air electrode. The firing conditions such as firing temperature may be appropriately determined depending on the materials and the like of the fuel electrode and the air electrode.

### EXAMPLES

Examples that more specifically disclose the electrolyte sheet for solid oxide fuel cells of the present invention and the method of producing an electrolyte sheet for solid oxide fuel cells of the present invention are described below. The present invention is not limited to these examples.

### Example 1

An electrolyte sheet of Example 1 was produced by the following method.

Preparing Sintered Zirconia Powder

Sintered zirconia was dry-pulverized, whereby a sintered zirconia powder having a volume-based cumulative particle size distribution with a particle size D₅₀ of 1.5 μm and a particle size D₉₉ of 6.1 μm was obtained.

The sintered zirconia was sintered scandia-stabilized zirconia obtained by sintering an unsintered scandia-stabilized zirconia powder. In other words, the sintered zirconia powder was a sintered scandia-stabilized zirconia powder.

Zirconia balls each having a diameter of 1 mm to 10 mm were used as pulverization media for a dry pulverizer.

The rotation number of a classifying rotor of the dry pulverizer was set to 4000 rpm or higher.

Preparing Ceramic Slurry

First, a sintered zirconia powder, an unsintered zirconia powder, a binder, a dispersant, and an organic solvent were compounded at a predetermined ratio. At this point, the sintered zirconia powder and the unsintered zirconia powder were mixed such that the weight percentage of the sintered zirconia powder with respect to the total weight of the sintered zirconia powder and the unsintered zirconia powder was 10 wt %. Then, the compounded product was stirred with media made of partially stabilized zirconia at 1000 rpm for three hours to form a ceramic slurry.

The unsintered zirconia powder was an unsintered scandia-stabilized zirconia powder. The unsintered zirconia powder had a volume-based cumulative particle size distribution with a particle size D₅₀ of 0.2 μm and a particle size D₉₉ of 1.8 μm.

The organic solvent was a solvent mixture of toluene and ethanol (weight ratio 7:3).

Producing Ceramic Green Sheet

First, the ceramic slurry was tape-casted by a known technique onto one main surface of a carrier film made of polyethylene terephthalate. Thus, a ceramic green tape was produced.

Then, the ceramic green tape was punched by a known technique into pieces having a predetermined size, and the carrier film was peeled off. Thus, ceramic green sheets were produced.

Producing Ceramic Plate Body

First, two ceramic green sheets were stacked and compression-bonded to produce an unsintered plate body.

Next, a mold having protrusions scattered on its surface was pressed against one main surface of the unsintered plate body to form recesses scattered thereon.

Next, a through hole penetrating the unsintered plate body in the thickness direction was formed using a drill.

Regarding the drilling process conditions, the rate of advance was set to 0.04 mm/rotation and the rotation number was set to 2000 rpm.

Next, the unsintered plate body was kept in a firing furnace at 400° C. for a predetermined time for degreasing. The degreased unsintered plate body was kept in a firing furnace at 1400° C. for five hours for sintering.

The unsintered plate body was fired as described above to sinter the unsintered plate body into a ceramic plate body. The ceramic plate body had a thickness of 120 μm.

Thus, an electrolyte sheet (ceramic plate body) of Example 1 was produced.

### Example 2

An electrolyte sheet of Example 2 was produced similarly to the electrolyte sheet of Example 1, except that the weight percentage of the sintered zirconia powder with respect to the total weight of the sintered zirconia powder and the unsintered zirconia powder was adjusted to 20 wt % in the preparing of the ceramic slurry.

### Example 3

An electrolyte sheet of Example 3 was produced similarly to the electrolyte sheet of Example 1, except that the weight percentage of the sintered zirconia powder with respect to the total weight of the sintered zirconia powder and the unsintered zirconia powder was adjusted to 50 wt % in the preparing of the ceramic slurry.

### Example 4

An electrolyte sheet of Example 4 was produced similarly to the electrolyte sheet of Example 1, except that a sintered zirconia powder having a volume-based cumulative particle size distribution with a particle size D₅₀ of 3.0 μm and a particle size D₉₉ of 7.9 μm was obtained in the preparing of the sintered zirconia powder.

### Example 5

An electrolyte sheet of Example 5 was produced similarly to the electrolyte sheet of Example 1, except that the weight percentage of the sintered zirconia powder with respect to the total weight of the sintered zirconia powder and the unsintered zirconia powder was adjusted to 5 wt % in the preparing of the ceramic slurry.

### Example 6

An electrolyte sheet of Example 6 was produced similarly to the electrolyte sheet of Example 1, except that the weight percentage of the sintered zirconia powder with respect to the total weight of the sintered zirconia powder and the unsintered zirconia powder was adjusted to 30 wt % in the preparing of the ceramic slurry.

### Example 7

An electrolyte sheet of Example 7 was produced similarly to the electrolyte sheet of Example 1, except that the weight percentage of the sintered zirconia powder with respect to the total weight of the sintered zirconia powder and the unsintered zirconia powder was adjusted to 40 wt % in the preparing of the ceramic slurry.

### Comparative Example 1

An electrolyte sheet of Comparative Example 1 was produced similarly to the electrolyte sheet of Example 1, except that the preparing of the sintered zirconia powder was not performed, i.e., no sintered zirconia powder was compounded in the preparing of the ceramic slurry.

### Comparative Example 2

An electrolyte sheet of Comparative Example 2 was produced similarly to the electrolyte sheet of Example 1, except that a sintered zirconia powder having a volume-based cumulative particle size distribution with a particle size D₃₀ of 1.3 μm and a particle size D₉₉ of 4.1 μm was obtained in the preparing of the sintered zirconia powder.

### Comparative Example 3

An electrolyte sheet of Comparative Example 3 was produced similarly to the electrolyte sheet of Example 1, except that a sintered zirconia powder having a volume-based cumulative particle size distribution with a particle size D₃₀ of 3.5 μm and a particle size D₉₉ of 8.2 μm was obtained in the preparing of the sintered zirconia powder.

### Comparative Example 4

An electrolyte sheet of Comparative Example 4 was produced similarly to the electrolyte sheet of Example 1, except that the weight percentage of the sintered zirconia powder with respect to the total weight of the sintered zirconia powder and the unsintered zirconia powder was adjusted to 55 wt % in the preparing of the ceramic slurry.

Table 1 shows the production conditions described above for producing the electrolyte sheets of Examples 1 to 7 and Comparative Examples 1 to 4. In Table 1, the particle size D₅₀ and the particle size D₉₉ of the sintered zirconia powder obtained in the preparing of the sintered zirconia powder are indicated by “D₅₀” and “D₉₉”, respectively, and the weight percentage of the sintered zirconia powder with respect to the total weight of the sintered zirconia powder and the unsintered zirconia powder in the preparing of the ceramic slurry is indicated by “Weight percentage”.

Evaluation

The electrolyte sheets of Examples 1 to 7 and Comparative Examples 1 to 4 were evaluated as follows.

Ceramic Grain Size Distribution

The ceramic grain size probability distribution was determined by the method described above for each of the electrolyte sheets of Examples 1 to 7 and Comparative Examples 1 to 4.

FIG. 9 is a graph of a ceramic grain size probability distribution in the electrolyte sheet of Example 1.

As shown in FIG. 9, the ceramic grain size probability distribution was confirmed to be wide with the presence of large-sized ceramic grains in the electrolyte sheet of Example 1.

The ceramic grain size probability distribution was confirmed to be wide with the presence of large-sized ceramic grains also in the electrolyte sheets of Examples 2 to 7, as in the electrolyte sheet of Example 1. In contrast, the ceramic grain particle size probability distribution was confirmed to be narrower in the electrolyte sheets of Comparative Examples 1 to 4 than in the electrolyte sheets of Examples 1 to 7.

In order to quantitatively show the results confirmed above, the number-based cumulative particle size distribution of the ceramic grains in each of the electrolyte sheets of Examples 1 to 7 and Comparative Examples 1 to 4 was determined by the above method.

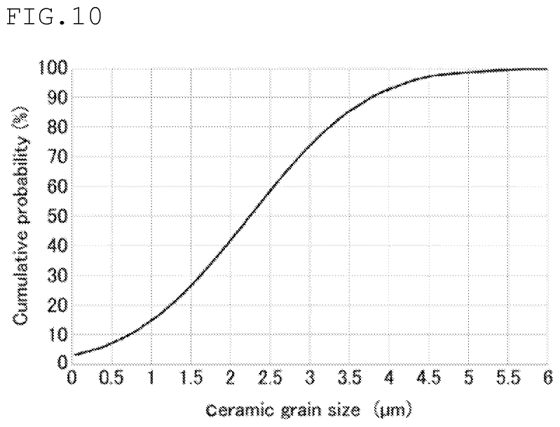

FIG. 10 is a graph of a number-based cumulative particle size distribution of ceramic grains in the electrolyte sheet of Example 1.

As shown in FIG. 10, the calculation for the electrolyte sheet of Example 1 found that the ceramic grains had a number-based cumulative particle size distribution with a particle size D₅₀ (also referred to as “median diameter”) at a 50% cumulative probability of 2.2 μm, a particle size D₁₀ at a 10% cumulative probability of 0.7 μm, a particle size D₉₀ at a 90% cumulative probability of 3.8 μm, and a difference of 3.1 μm between the particle size D₉₀ and the particle size D₁₀.

Also for each of the electrolyte sheets of Examples 2 to 7 and Comparative Examples 1 to 4, the particle size D₅₀, the particle size D₁₀, and the particle size D₉₀ were read from the number-based cumulative particle size distribution of the ceramic grains, and the difference between the particle size D₉₀ and the particle size D₁₀ was calculated. Table 1 shows the results. Regarding the evaluation of the ceramic grain size distribution, Table 1 shows the particle size D₅₀, the particle size D₁₀, the particle size D₉₀, and the difference between the particle size D₉₀ and the particle size D₁₀ in the number-based cumulative particle size distribution of the ceramic grains, which are respectively indicated by “D₅₀”, “D₁₀”, “D₉₀”, and “D₉₀-D₁₀”.

Strength

The strength of each of the electrolyte sheets of Examples 1 to 7 and Comparative Examples 1 to 4 was evaluated as follows. First, the electrolyte sheet was placed at the center of a precision universal tester “AGS-X” available from Shimadzu Corporation, with lower jigs being spaced apart by 32.5 mm from each other and upper jigs being spaced apart by 65 mm from each other. The upper jigs were lowered at a rate of 5 mm/min, whereby a four-point bending test was performed, and the strength of the electrolyte sheet was measured. Table 1 shows the measured strength of the electrolyte sheet according to the following criteria.
Good: The strength was 200 MPa or higher.
Poor: The strength was lower than 200 MPa.

Conductivity

The electrolyte sheets of Examples 1 to 7 and Comparative Examples 1 to 4 were evaluated in terms of conductivity as follows. First, an electrode was formed on one main surface of the electrolyte sheet to produce a sample. Next, the sample was brought to a high temperature of 864° C.±1° C. and left standing for 30 minutes or longer. Subsequently, the resistance of the sample at a high temperature was measured at a two-minute interval. The measurement was repeated three times. Subsequently, the conductivity was calculated from each of the three measured values of the resistance, and an average conductivity was determined as the conductivity at a high temperature. Then, the conductivity of the electrolyte sheet was evaluated according to the following criteria based on the conductivity at a high temperature. Table 1 shows the results.
Good: The conductivity at a high temperature was 135 mS/cm or higher.
Fair: The conductivity at a high temperature was 125 mS/cm or higher and lower than 135 mS/cm.
Poor: The conductivity at a high temperature was lower than 125 mS/cm.

TABLE 1

| | Preparing | | Preparing | Particle size | | | | | |
|---|---|---|---|---|---|---|---|---|---|
| | sintered | | ceramic | distribution | | | | | |
| | zirconia | | slurry | of ceramic grains | | | | | |
| | powder | | Weight | | | | D₉₀- | | Con- |
| | D₅₀ | D₉₉ | percentage | D₅₀ | D₁₀ | D₉₀ | D₁₀ | | ducti- |
| | (μm) | (μm) | (wt %) | (μm) | (μm) | (μm) | (μm) | Strength | vity |
| Example 1 | 1.5 | 6.1 | 10 | 2.2 | 0.7 | 3.8 | 3.1 | Good | Good |
| Example 2 | 1.5 | 6.1 | 20 | 2.3 | 0.8 | 3.6 | 2.8 | Good | Good |
| Example 3 | 1.5 | 6.1 | 50 | 2.4 | 0.9 | 3.4 | 2.5 | Good | Fair |
| Example 4 | 3.0 | 7.9 | 10 | 2.3 | 0.8 | 3.5 | 2.7 | Good | Good |
| Example 5 | 1.5 | 6.1 | 5 | 2.2 | 0.7 | 3.2 | 2.5 | Good | Good |
| Example 6 | 1.5 | 6.1 | 30 | 2.3 | 0.8 | 3.4 | 2.6 | Good | Good |
| Example 7 | 1.5 | 6.1 | 40 | 2.3 | 0.9 | 3.4 | 2.5 | Good | Fair |
| Comparative | — | — | 0 | 2.0 | 0.7 | 2.8 | 2.1 | Poor | Good |
| Example 1 | | | | | | | | | |
| Comparative | 1.3 | 4.1 | 10 | 2.2 | 0.9 | 2.9 | 2.0 | Poor | Good |
| Example 2 | | | | | | | | | |
| Comparative | 3.5 | 8.2 | 10 | 2.5 | 1.1 | 3.5 | 2.4 | Poor | Good |
| Example 3 | | | | | | | | | |
| Comparative | 1.5 | 6.1 | 55 | 2.7 | 1.2 | 3.6 | 2.4 | Poor | Poor |
| Example 4 | | | | | | | | | |

As shown in Table 1, in the production of the electrolyte sheets of Examples 1 to 7, a sintered zirconia powder having a volume-based cumulative particle size distribution with a particle size D₅₀ of 3 μm or less and a particle size D₉₉ of 6 μm or more was prepared in the preparing of the sintered zirconia powder, and further, the weight percentage of the sintered zirconia powder with respect to the total weight of the sintered zirconia powder and the unsintered zirconia powder was adjusted to 50 wt % or less in the preparing of the ceramic slurry. In this case, the electrolyte sheets of Examples 1 to 7 each had high strength, with the ceramic grains having a number-based cumulative particle size distribution with a difference of 2.5 μm or more between the particle size D₉₀ and the particle size D₁₀. The electrolyte sheets of Examples 1 to 7 each also had a high conductivity of 125 mS/cm or higher at a high temperature.

As shown in Table 1, in the production of the electrolyte sheet of Comparative Example 1, the preparing of the sintered zirconia powder was not performed, i.e., no sintered zirconia powder was compounded in the preparing of the ceramic slurry. In this case, the electrolyte sheet of Comparative Example 1 had low strength, with the ceramic grains having a number-based cumulative particle size distribution with a difference of less than 2.5 μm between the particle size D₉₀ and the particle size D₁₀.

As shown in Table 1, in the production of the electrolyte sheet of Comparative Example 2, a sintered zirconia powder having a volume-based cumulative particle size distribution with a particle size D₅₀ of 3 μm or less and a particle size D₉₉ of less than 6 μm was obtained in the preparing of the sintered zirconia powder. In this case, the electrolyte sheet of Comparative Example 2 had low strength, with the ceramic grains having a number-based cumulative particle size distribution with a difference of less than 2.5 μm between the particle size D₉₀ and the particle size D₁₀.

Producing an electrolyte sheet by the production method disclosed in Patent Literature 1 confirmed the obtainment of a sintered zirconia powder having a volume-based cumulative particle size distribution with a particle size D₅₀ of 3 μm or less and a particle size D₉₉ of less than 6 μm in preparing of a sintered zirconia powder, as in the production of the electrolyte sheet of Comparative Example 2. Thus, a decrease in the strength was confirmed in the electrolyte sheet produced by the production method disclosed in Patent Literature 1 when it was made thinner to a thickness of 120 μm, with the ceramic grains having a number-based cumulative particle size distribution with a difference of less than 2.5 μm between the particle size D₉₀ and the particle size D₁₀, as in the electrolyte sheet of Comparative Example 2.

As shown in Table 1, in the production of the electrolyte sheet of Comparative Example 3, a sintered zirconia powder having volume-based cumulative particle size distribution with a particle size D₉₉ of 6 μm or more and a particle size D₅₀ of more than 3 μm was obtained in the preparing of the sintered zirconia powder. In this case, the electrolyte sheet of Comparative Example 3 had low strength, with the ceramic grains having a number-based cumulative particle size distribution with a difference of less than 2.5 μm between the particle size D₉₀ and the particle size D₁₀.

As shown in Table 1, in the production of the electrolyte sheet of Comparative Example 4, the weight percentage of the sintered zirconia powder with respect to the total weight of the sintered zirconia powder and the unsintered zirconia powder was adjusted to higher than 50 wt % in the preparing of the ceramic slurry. In this case, the electrolyte sheet of Comparative Example 4 had low strength, with the ceramic grains having a number-based cumulative particle size distribution with a difference of less than 2.5 μm between the particle size D₉₀ and the particle size D₁₀.

### REFERENCE SIGNS LIST

1g ceramic green sheet
1s unsintered plate body
1t ceramic green tape
10, 130 electrolyte sheet for solid oxide fuel cells (electrolyte sheet)
10p ceramic plate body
100 unit cell for solid oxide fuel cells (unit cell)
110 fuel electrode
120 air electrode
X casting directions
Y directions perpendicular to casting directions

1. An electrolyte sheet for solid oxide fuel cells, the electrolyte sheet comprising:
a ceramic plate body including ceramic grains containing sintered zirconia,
wherein the ceramic grains have a number-based cumulative particle size distribution with a difference of 2.5 μm or more between a particle size D₉₀ at a 90% cumulative probability and a particle size D₁₀ at a 10% cumulative probability.

2. The electrolyte sheet according to claim 1, wherein the sintered zirconia is sintered scandia-stabilized zirconia or sintered yttria-stabilized zirconia.

3. The electrolyte sheet according to claim 1, wherein the sintered zirconia is sintered cubic zirconia.

4. The electrolyte sheet according to claim 1, wherein the number-based cumulative particle size distribution is 2.5 μm to 3.5 μm between the particle size D₉₀ and the particle size D₁₀.

5. The electrolyte sheet according to claim 1, wherein the particle size D₉₀ of the ceramic grains is 3 μm to 4 μm.

6. The electrolyte sheet according to claim 5, wherein the particle size D₁₀ of the ceramic grains is 0.5 μm to 1 μm.

7. The electrolyte sheet according to claim 1, wherein the particle size D₁₀ of the ceramic grains is 0.5 μm to 1 μm.

8. A unit cell for solid oxide fuel cells, the unit cell comprising:
a fuel electrode;
an air electrode; and
the electrolyte sheet for solid oxide fuel cells according to claim 1 between the fuel electrode and the air electrode.

9. A method of producing an electrolyte sheet for solid oxide fuel cells, the method comprising:
preparing a sintered zirconia powder having a volume-based cumulative particle size distribution with a particle size D₅₀ at a 50% cumulative probability of 3 μm or less and a particle size D₉₉ at a 99% cumulative probability of 6 μm or more;
preparing a ceramic slurry by mixing the sintered zirconia powder and an unsintered zirconia powder such that a weight percentage of the sintered zirconia powder with respect to a total weight of the sintered zirconia powder and the unsintered zirconia powder is 5 wt % to 50 wt %;
molding the ceramic slurry into a ceramic green sheet; and
sintering the ceramic green sheet to produce a ceramic plate body.

10. The method of producing an electrolyte sheet for solid oxide fuel cells according to claim 9, wherein the particle size D₅₀ is 0.5 μm to 3 μm.

11. The method of producing an electrolyte sheet for solid oxide fuel cells according to claim 10, wherein the particle size D₉₉ is 6 μm to 8.5 μm.

12. The method of producing an electrolyte sheet for solid oxide fuel cells according to claim 9, wherein the particle size D₉₉ is 6 μm to 8.5 μm.

13. The method of producing an electrolyte sheet for solid oxide fuel cells according to claim 9, wherein the sintered zirconia powder is a sintered scandia-stabilized zirconia powder or a sintered yttria-stabilized zirconia powder.

14. The method of producing an electrolyte sheet for solid oxide fuel cells according to claim 9, wherein the sintered zirconia powder is a sintered cubic zirconia powder.

15. The method of producing an electrolyte sheet for solid oxide fuel cells according to claim 9, wherein the weight percentage of the sintered zirconia powder with respect to the total weight of the sintered zirconia powder and the unsintered zirconia powder in the ceramic slurry is 5 wt % to 30 wt %.

16. The method of producing an electrolyte sheet for solid oxide fuel cells according to claim 9, wherein the unsintered zirconia powder has a volume-based cumulative particle size distribution with a particle size D₅₀ at a 50% cumulative probability of 0.1 μm to 0.3 μm and a particle size D₉₉ at a 99% cumulative probability of 1.5 μm to 2.5 μm.
